(19) United States
(12) Patent Application Publication
(10) Pub. No.: US 2005/0076529 A1
(43) Pub. Date: Apr. 14, 2005

(54) Hand dryer

(75) Inventor: Thomas Michael Holmes, NorthYorkshire (GB)

Correspondence Address: VENABLE, BAETJER, HOWARD AND CIVILETTI, LLP, P.O. BOX 34385, WASHINGTON, DC, 20043-9998, US

(73) Assignee: P & L Systems LLC, Marietta, GA (US)

(21) Appl. No.: 10/683,581

(22) Filed: Oct. 14, 2003

(51) Int. Cl. F26B 19/00

(52) U.S. Cl. 34/90

(57) ABSTRACT

A hand dryer 2 consists of an outer housing with a main fan 8 which draws air into the housing and out of a first outlet 12 on operation by a user. The dryer 2 also incorporates a substantially constantly operated second fan 22 which provides a substantially constant sterilising air flow.

The present invention relates to dryers, and particularly although not exclusively, to hand dryers, for example, for use in a washroom.

A problem associated with traditional hand dryers is that because they tend to be installed and used in a damp environment, such as a washroom, the internal area of the hand dryer is a breeding ground for unwanted micro-organisms, such as bacteria. Accordingly, washrooms tend to have a high concentration of airborne bacteria, which are able to multiply in the internal workings of the hand dryer. Also bacteria are present on other surfaces and in the atmosphere of the washroom. Therefore, when one uses a traditional hand dryer, the micro-organisms contained within the hand dryer are expelled on to the user's hands during the activation of the drying cycle thereby causing hygiene problems.

As a consequence, users of hand dryers are reverting to using paper towels as a solution to hand drying, which towels reduce the hygiene worries associated with using traditional hand dryers. However, a problem with using hand towels is that it is an environmental problem due to the constant demand for paper.

One attempt at combating this is to include a UV-C germicidal tube inside a hand dryer, which tube produces UV radiation, to disinfect air sucked in to the dryer and, destroy micro-organisms which are airborne in the washroom. In addition, the UV-C tube disinfects micro-organisms inside the dryer itself. However, although the air intake and output ports and the UVC tube are configured in such a way as to ensure that the air is sterilised, the sterilised air will only be dispelled into local environments periodically during activation of the drying mechanism, i.e. when someone uses the dryer after washing their hands. Accordingly, there are often long periods of time during which sterilised air is not being dispelled in to the wash room, which allows the breeding of unwanted micro-organisms. Furthermore, due to the periodic activation of the dryer, a flow of sterile air inside the dryer is also produced only periodically which can enable a population of bacteria to grow therein.

It is an aim of embodiments of the present invention, to address the above problems, and to provide a dryer which is more hygienic than traditional dryers.

According to a first aspect of the present invention, there is provided a dryer comprising air stream generation means adapted to generate an intermittent flow of air with which a user may dry himself, and to generate a substantially continuous flow of substantially sterile air.

Preferably the air stream generation means includes a first fan to generate the intermittent, drying, air stream. Preferably the air stream generation means includes a second fan, to generate the substantially continuous air stream.

Preferably, the dryer comprises at least one air inlet. Preferably, the first fan, and preferably the second fan, is adapted to draw air in to the dryer through the air inlet.

Preferably, the dryer comprises at least one air outlet. Preferably, the first fan and preferably, the second fan, is adapted to blow air out of the dryer through the air outlet. Preferably, the dryer comprises first and second outlets. Preferably, the first fan is adapted to blow air out of the first outlet, and preferably the second fan is adapted to blow air out of the second outlet.

Preferably, the dryer comprises sterilising means adapted to sterilise the air, preferably the air that is drawn in through the inlet. Preferably, the sterilising means comprises at least one UV, preferably UV-C, light or bulb. Preferably, the sterilising means is located substantially adjacent the air inlet, and may extend away therefrom.

Preferably, the UV bulb is contained within a housing, which housing extends upwardly away from the air inlet. Preferably, the housing comprises at least one venting means, through which a flow of air may pass. Preferably, the venting means comprises a vent, which preferably comprises a plurality of apertures extending through a wall of the housing. Preferably, the housing comprises first and second venting means, which are preferably not directly opposite each other.

Preferably, the first fan is adapted to draw air in through the air inlet, preferably passed the sterilising means, and preferably through the first venting means and, preferably out through the first outlet. Preferably, the second fan is adapted to draw air in through the air inlet, preferably passed the sterilising means, and preferably through the second venting means and, preferably out through the second outlet.

The dryer may include fragrancing means, which is adapted to produce a fragrance. Preferably, the fragrancing means is located substantially adjacent the second fan, more preferably upstream of the second fan. Preferably, the second fan is adapted to entrain fragrance in the sterile air flow.

Preferably, the dryer is adapted to be used to dry any part of a person's body. Preferably, the dryer is a hand/face dryer, which may be adapted to be installed in a washroom or the like.

Advantageously, the second fan of the dryer provides a substantially constant stream of substantially sterile air into the local environment. In addition, the continuous stream of sterile air is also fragranced, thereby removing the necessity for separate air sterilisers and fragrances.

Preferably, the sterilising means illuminate at least part of the first outlet. Preferably, the sterilising means at least partly sterilise the first outlet and a passage leading thereto. Preferably, in use, a sterilising air flow passes through the first outlet and a passage leading thereto, said sterilising air flow being driven by convection currents or the general movement of air in and around the dryer, potentially due to the substantially constant air flow generated by the second fan.

The invention extends to a method of sterilising an air flow using the dryer of the first aspect.

For a better understanding of the invention, and to show how embodiments of the same may be carried into effect, reference will now be made, by way of example, to the accompanying diagrammatic drawings in which:

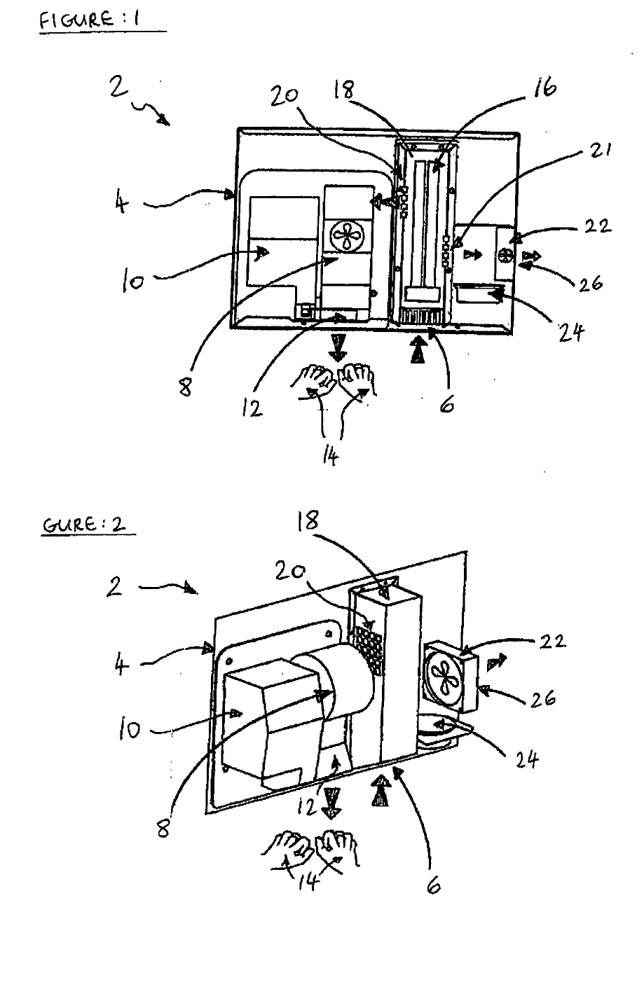

FIG. 1 shows a schematic plan view of a hand dryer; and

FIG. 2 shows a schematic perspective view of a rear of the hand dryer.

Referring to FIGS. 1 and 2, there is shown a hand dryer 2, which consists of an outer housing 4 which can either be free standing or wall-mounted. The dryer 2 has a main fan 8, which draws air in to the housing 4 via an inlet port 6 on a lower surface thereof, and blows out the air via a first outlet port 12 which is also on the lower surface of the housing 4, and onto a user's hands 14. The air is heated by a heater 10 which is located adjacent the primary fan 8 inside the housing 4 so that the air is not cold when it is blown on to the user's hands.

As shown in the Figures, the dryer 2 includes two UV-C tubes 16 which are contained within a casing 18, which extends upwardly inside the housing 4 of the dryer 2 away from the air inlet port 6. The casing 18 completely covers the UV-C tubes 16 but has a first air vent 20 which is located on one side of the casing 18 approximately adjacent the fan 8, and a second air vent 21 which is located on the opposite side of the casing 18, but nearer to the inlet port 6. Hence, the two vents 20,21 are on opposite sides of the casing 18, but not directly opposite each other.

When the dryer 2 is activated by a user, air is drawn in to the housing 4 by fan 8 through the air inlet port 6, upwards through the casing 18 and passed the UV tubes 16. The air is then sucked out of the casing 18 through the vent 20, and towards the fan 8, from where it is then blown out of the dryer 2 through the outlet port 12. Hence, the air being sucked in to the dryer 2 is sterilised by passing along the length of the UV-C tubes 16 before it is blown back out through the outlet port 12 onto the user's hands 14.

The hand dryer 2 is configured so that the first fan 8 is switched on only when a user either activates it manually, or automatically when the user places his hands 14 thereunder. Hence, the fan 8 is only switched on periodically when required for use by a user wishing to dry their hands 14.

The dryer 2 also consists of a second fan 22, which is smaller than the first fan 8, and which is located on the opposite side of the UV tubes 16 and casing 18 to that of the primary fan 8 and heater 10, The second fan 22 is configured so that it constantly sucks air in to the dryer 2 through the air inlet port 6, upwardly through the inside of the casing 16 and passed the UV tubes 16. The air is then sucked through the vent 21 in the side of the casing 18, and then blown out of the dryer 2 in to the atmosphere through a second outlet port 26, which is located on a side of the housing 4 of the dryer 2.

The second fan 22 produces an air flow of approximately 40-50 m³/hr, which is determined by the size of the environment in which the dryer 2 is located. For example, if the dryer 2 was placed in a large wash room, the second fan 22 could be configured to produce a larger air flow to compensate for the larger volume of air which needs to be kept sterile. Typically the air flow is based on a turnaround of all of the air in a room in one hour. Thus the throughflow should be approximately equal to the volume of the wash room. Alternatively, the cumulative throughput for a number of dryers should be about equal to the volume of the wash room.

Continuous sterilisation of the passage between the vent 20 and the first outlet 12 is achieved partly by the UV tubes 16 illuminating part of the passage and partly by a constant, low-level air flow through the passage from the vent 20 due to convection currents, general air flow or air flow generated by the second fan 22.

The hand dryer 2 has a replaceable fragrance source 24 located underneath the second fan 22. Therefore, as fragrance 24 rises upwards inside the housing 4 of the dryer 2, it is entrained by the flow of sterilised air being sucked through vent 21 by the second fan 22, and is blown out of the outlet port 26 as fragranced and sterilised air. The second fan 22 therefore generates a constant flow of sterilised, fragranced air, which is expelled in to the environment, which lowers the number of airborne micro-organisms therein. In addition, the concentration of bacteria growing on surfaces will also be reduced. In addition, the second fan 22 generates a constant flow of sterile air inside the housing 4, which will lower the number of micro-organisms living and growing inside the dryer 2.

Advantages of the hand dryer 2 reside in the constant, continual operation of the secondary fan 22, which sterilises the interior of the dryer 2 and constantly dispels sterilised air into the environment in which the hand dryer 2 is placed. In addition, the constant stream of sterilised air is fragranced by the fragrance source 24 to improve the smell of the room in which the dryer 2 is mounted. The invention provides a constant stream of sterile and fragranced air into the local environment, thereby removing the necessity for separate air sterilisers and fragrances.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A dryer comprising air stream generation means adapted to generate an intermittent flow of air with which a user may dry himself, and to generate a substantially continuous flow of substantially sterile air.

2. A dryer as claimed in claim 1, in which the air stream generation means includes a first fan to generate the intermittent, drying, air stream.

3. A dryer as claimed in claim 1, in which the air stream generation means includes a second fan, to generate the substantially continuous air stream.

4. A dryer as claimed in claim 2, in which the first fan is adapted to blow air out of a first outlet.

5. A dryer as claimed in claim 3, in which the second fan is adapted to blow air out of a second outlet.

6. A dryer as claimed in claim 1, which comprises sterilising means adapted to sterilise air that is drawn in through an inlet of the dryer.

7. A dryer as claimed in claim 6, in which the sterilising means is located substantially adjacent the inlet and extends away therefrom.

8. A dryer as claimed in claim 6, in which the first fan is adapted to draw air in through the air inlet, passed the sterilising means, through a first venting means and out through a first outlet.

9. A dryer as claimed in claim 6, in which the second fan is adapted to draw air in through the inlet, passed the sterilising means, through second venting means and out of a second outlet.

10. A dryer as claimed in claim 1, which includes fragrancing means adapted to produce a fragrance.

11. A dryer as claimed in claim 1, which is a hand/face dryer.

12. A dryer as claimed in claim 6, in which the sterilising means is adapted to illuminate at least part of the first outlet.

13. A dryer as claimed in claim 6, in which the sterilising means is adapted to at least partly sterilise the first outlet and a passage leading thereto.

14. A dryer as claimed in claim 6, in which, in use, a sterilising air flow passes through the first outlet and a passage leading thereto, said sterilising air flow being driven by convection currents and/or the general movement of air in and around the dryer and/or due to substantially constant air flow generated by the second fan.

15. A method of sterilising an air flow comprises operating a dryer according to claim 1.
